(19) United States
(12) Patent Application Publication
(10) Pub. No.: US 2026/0014773 A1
(43) Pub. Date: Jan. 15, 2026

(54) SUPPORT MEMBER AND METHOD FOR MANUFACTURING SAME, AND FOLDABLE DISPLAY DEVICE

(71) Applicant: BOE Technology Group Co., Ltd., Beijing (CN)

(72) Inventors: Biao GAO, Beijing (CN); Linlin XU, Beijing (CN); Yufei WANG, Beijing (CN); Zhao LI, Beijing (CN); Song ZHANG, Beijing (CN)

(73) Assignee: BOE Technology Group Co., Ltd., Beijing (CN)

(21) Appl. No.: 18/994,159

(22) PCT Filed: Feb. 7, 2024
(86) PCT No.: PCT/CN2024/076700

§ 371 Date: Jan. 14, 2025

(51) Int. Cl. B32B 3/26; B32B 3/30; B32B 7/022; B32B 7/04

(52) U.S. Cl. CPC B32B 3/263; B32B 3/30; B32B 7/022; B32B 7/04; B32B 2307/54; B32B 2307/7375; B32B 2457/20

(57) ABSTRACT

Provided is a support member. The support member includes a support layer and an isolation layer on a first surface of the support layer; wherein the support layer has a first planar region, a bending region, and a second planar region sequentially connected along a first direction, wherein a length direction of the bending region is a second direction, the second direction being intersected with the first direction, and the support layer includes a plurality of openwork structures disposed in the bending region; the isolation layer is disposed in the first planar region, the bending region, and the second planar region, and covers the bending region; and a modulus of the isolation layer ranges from 10 GPa to 250 Gpa, and a thickness of the isolation layer is less than a thickness of the support layer.

### CROSS-REFERENCE TO RELATED APPLICATION

This application is a U.S. national phase application based on PCT/CN2024/076700, filed on Feb. 7, 2024, the disclosure of which is incorporated herein by reference in its entirety.

### TECHNICAL FIELD

Embodiments of the present disclosure relate to the field of display technology, and in particular, relate to a support member and a method for manufacture the same, and a foldable display device.

### BACKGROUND

Foldable display devices have a wide range of application scenarios in life, such as cell phones, tablets, and other electronic devices. The foldable display device usually includes a laminated support member and a display panel.

### SUMMARY

The embodiments of the present disclosure provide a support member and a method for manufacture the same, and a foldable display device. The technical solutions are as follows.

According to some embodiments of the present disclosure, a support member is provided. The support member the support member includes a support layer and an isolation layer on a first surface of the support layer; wherein the support layer has a first planar region, a bending region and a second planar region sequentially connected along a first direction, wherein a length direction of the bending region is a second direction, the second direction being intersected with the first direction, and the support layer includes a plurality of openwork structures disposed in the bending region; the isolation layer is disposed in the first planar region, the bending region, and the second planar region, and covers the bending region; and a modulus of the isolation layer ranges from 10 GPa to 250 Gpa, and a thickness of the isolation layer is less than a thickness of the support layer.

In some embodiments, the support member further includes a first transition region and a second transition region, wherein the first transition region is disposed between the first planar region and the bending region, and the second transition region is disposed between the bending region and the second planar region; and the isolation layer is further disposed in the first transition region and the second transition region, and each of the isolation layer disposed in the first transition region and the isolation layer disposed in the second transition region has a first recessed pattern.

In some embodiments, the first recessed pattern includes a first elongated groove, wherein a dimension of the first elongated groove along the second direction is equal to a dimension of the isolation layer along the second direction, and a depth of the first elongated groove is less than or equal to the thickness of the isolation layer.

In some embodiments, the first recessed pattern includes a first elongated groove, wherein a length direction of the first elongated groove is the second direction, a dimension of the first elongated groove along the second direction is less than a dimension of the isolation layer along the second direction, and a depth of the first elongated groove is equal to the thickness of the isolation layer.

In some embodiments, the first recessed pattern includes a plurality of first elongated grooves arranged along the second direction, wherein a length direction of each of the plurality of the first elongated grooves is the second direction.

In some embodiments, along the first direction, the first recessed pattern has a first reference point closest to the bending region and a second reference point farthest from the bending region, and a distance between the first reference point and the second reference point ranges from 5 μm to 100 μm.

In some embodiments, the first recessed pattern includes a plurality of first recessed structure groups, wherein the plurality of first recessed structure groups are arranged along the first direction, each of the plurality of first recessed structure groups includes a plurality of first recessed structures arranged along the second direction, and a length direction of each of the plurality of first recessed structures is the second direction.

In some embodiments, the plurality of first recessed structure groups includes a first target recessed structure group and a second target recessed structure group, wherein the first target recessed structure group and the second target recessed structure group are adjacent to each other, and the first target recessed structure group is disposed on a side, away from the bending region, of the second target recessed structure group; and the first recessed structure is a first elongated groove, and an orthographic projection of each of two adjacent first elongated grooves in the second target recessed structure group on a reference surface partially is coincident with an orthographic projection of the first elongated groove in the first target recessed structure group on the reference surface, wherein the reference surface is perpendicular to the first surface and parallel to the second direction.

In some embodiments, the first target recessed structure group and the second target recessed structure group satisfy at least one of: a number of the first elongated grooves in the first target recessed structure group being less than or equal to a number of the first elongated grooves in the second target recessed structure group; a depth of the first elongated groove in the first target recessed structure group being less than or equal to a depth of the first elongated groove in the second target recessed structure group; along the first direction, a dimension of the first elongated groove in the first target recessed structure group being less than or equal to a dimension of the first elongated groove in the second target recessed structure group; or along the second direction, a dimension of the first elongated groove in the first target recessed structure group being less than or equal to a dimension of the first elongated groove in the second target recessed structure group.

In some embodiments, a distance between two adjacent first recessed structure group ranges from 5 μm to 20 μm.

In some embodiments, along the first direction, the first recessed pattern has a first reference point closest to the bending region and a second reference point farthest away from the bending region, and a distance between the first reference point and the second reference point ranges from 0.1 mm to 10 mm.

In some embodiments, along the first direction, a distance between the first elongated groove closest to the bending region in the first recessed pattern and one of the plurality of openwork structures closest to the first recessed pattern in the support layer ranges from 2 mm to 20 mm; or the support layer further includes a plurality of recessed structures, wherein the plurality of recessed structures are disposed on both sides of the plurality of openwork structures along the first direction, and along the first direction, a distance between the first elongated groove closest to the bending region in the first recessed pattern and one of the recessed structures closest to the first recessed pattern in the first recessed pattern ranges from 2 mm to 20 mm.

In some embodiments, a ratio of the depth of the first elongated groove to the thickness of the isolation layer ranges from ⅓ to 1.

In some embodiments, the isolation layer is made of a metallic material or an inorganic non-metallic material.

In some embodiments, the support member further includes a plurality of first filling structures, disposed in the first recessed pattern; wherein a modulus of each of the plurality of first filling structures is less than the modulus of the isolation layer.

In some embodiments, the support member further includes a first adhesive layer, the first adhesive layer being disposed on a side, away from the support layer, of the isolation layer; wherein each of the first adhesive layer disposed in the first transition region and the first adhesive layer disposed in the second transition region has a second recessed pattern; wherein an orthographic projection of the second recessed pattern on the first surface at least partially is coincident with an orthographic projection of the first recessed pattern on the first surface.

In some embodiments, the orthographic projection of the second recessed pattern on the first surface partially is coincident with the orthographic projection of the first recessed pattern on the first surface, and the second recessed pattern includes a second elongated groove, wherein a length direction of the second elongated groove is the second direction, a length of the second elongated groove along the second direction is equal to the dimension of the first adhesive layer along the second direction, and a depth of the second elongated groove is equal to a thickness of the first adhesive layer.

In some embodiments, the support member further includes a first adhesive layer, the first adhesive layer being disposed on a side, away from the support layer, of the isolation layer; and the first adhesive layer disposed in the bending region has a second recessed pattern.

In some embodiments, the second recessed pattern includes a second elongated groove, wherein a dimension of the second elongated groove along the first direction ranges from 1 mm to 30 mm.

In some embodiments, the support member further includes a second filling structure, disposed in the second recessed pattern; wherein a modulus of the second filling structure is less than the modulus of the isolation layer.

In some embodiments, the support member further includes a second adhesive layer, disposed between the isolation layer and the support layer; wherein each of the second adhesive layer disposed in the first transition region and the second adhesive layer disposed in the second transition region has a third recessed pattern; wherein an orthographic projection of the third recessed pattern on the first surface at least partially is coincident with an orthographic projection of the first recessed pattern on the first surface.

In some embodiments, the orthographic projection of the third recessed pattern on the first surface is coincident with the orthographic projection of the first recessed pattern on the first surface, and the third recessed pattern includes a plurality of third recessed structure groups, wherein the plurality of third recessed structure groups are arranged along the first direction, and each of the plurality of third recessed structure groups includes a plurality of third recessed structures arranged along the second direction; wherein the plurality of third recessed structure groups include a third target recessed structure group and a fourth target recessed structure group, wherein the third target recessed structure group and fourth target recessed structure group are adjacent to each other, and the third target recessed structure group is disposed on a side, away from the bending region, of the fourth target recessed structure group; and a depth of the third recessed structure in the third target recessed structure group is less than a depth of the third recessed structure in the fourth target recessed structure group.

In some embodiments, the orthographic projection of the third recessed pattern on the first surface partially is coincident with the orthographic projection of the first recessed pattern on the first surface, and the third recessed pattern includes a third elongated groove, wherein a dimension of the third elongated groove along the second direction is equal to a dimension of the second adhesive layer along the second direction, and a depth of the third elongated groove is equal to a thickness of the second adhesive layer.

In some embodiments, the support member further includes a second adhesive layer, the second adhesive layer being disposed between the isolation layer and the support layer; and the second adhesive layer disposed in the bending region has a third recessed pattern.

In some embodiments, the third recessed pattern includes a third elongated groove, wherein a dimension of the third elongated groove along the first direction ranges from 1 mm to 30 mm.

In some embodiments, the support member further includes a third filling structure, disposed in the third recessed pattern; wherein a modulus of the third filling structure is less than the modulus of the isolation layer, or the modulus of the third filling structure is less than the modulus of the isolation layer, and a thermal conductivity of the third filling structure is greater than or equal to 110 w/(m*k).

In some embodiments, the support member further includes a first transition region and a second transition region, wherein the first transition region is disposed between the first planar region and the bending region, the second transition region is disposed between the bending region and the second planar region, the isolation layer is further disposed in the first transition region and the second transition region, the isolation layer has a whole layer structure, and the support member further includes a first adhesive layer and a second adhesive layer, the first adhesive layer being disposed on a side, away from the support layer, of the isolation layer, and the second adhesive layer being disposed between the isolation layer and the support layer; each of the first adhesive layer disposed in the first transition region and the first adhesive layer disposed in the second transition region has a second recessed pattern, or the first adhesive layer disposed in the bend region has a second recessed pattern; and/or each of the second adhesive layer disposed in the first transition region and the second adhesive layer disposed in the second transition region has a third recessed pattern, or the second adhesive layer disposed in the bending region has a third recessed pattern.

According to some embodiments of the present disclosure, a method for manufacturing a support member is provided. The method includes: providing a support layer; and forming an isolation layer on a first surface of the support layer; wherein the support member has a first planar region, a bending region and a second planar region sequentially connected along a first direction, wherein an extension direction of the bending region of the support member is a second direction, the second direction being intersected with the first direction; and the support layer includes a plurality of openwork structures disposed in the bending region, the isolation layer is disposed in the first planar region, the bending region and the second planar region, the isolation layer includes a whole layer structure disposed in the bending region, a modulus of the isolation layer ranges from 10 GPa to 250 Gpa, and a thickness of the isolation layer is than a thickness of the support layer.

According to some embodiments of the present disclosure, a foldable display device is provided. The foldable display device includes a laminated display panel and the support member as described in any of the above embodiments, wherein a side, away from the support layer, of the support member is connected to a back side of the display panel.

### BRIEF DESCRIPTION OF DRAWINGS

For clearer descriptions of the technical solutions according to the embodiments of the present disclosure, the following briefly introduces the accompanying drawings required for describing the embodiments. Apparently, the accompanying drawings in the following description show merely some examples of the present disclosure, and those of ordinary skill in the art may still derive other drawings from these accompanying drawings without creative efforts.

FIG. 1 is a schematic diagram of a cross-sectional structure of a support member according to some embodiments of the present disclosure

FIG. 2 is a schematic diagram of a planar structure of a support member according to some embodiments of the present disclosure;

FIG. 3 is a pen drop test result of a foldable display device using isolation layers with different modulus materials according to some embodiments of the present disclosure;

FIG. 4 is a schematic diagram of a cross-sectional structure of a support member in a bending state according to some embodiments of the present disclosure;

FIG. 5 is a schematic diagram of a planar structure of another support member according to some embodiments of the present disclosure;

FIG. 6 is a schematic diagram of a planar structure of another support member according to some embodiments of the present disclosure;

FIG. 7 is a schematic diagram of a planar structure of another support member according to some embodiments of the present disclosure;

FIG. 8 is a schematic diagram of a cross-sectional structure of another support member according to some embodiments of the present disclosure;

FIG. 9 is a schematic diagram of a cross-sectional structure of another support member according to some embodiments of the present disclosure;

FIG. 10 is a schematic diagram of a cross-sectional structure of another support member according to some embodiments of the present disclosure;

FIG. 11 is a schematic diagram of a planar structure of the support member in FIG. 10;

FIG. 12 is a schematic diagram of a cross-sectional structure of another support member according to some embodiments of the present disclosure;

FIG. 13 is a schematic diagram of a planar structure of the support member in FIG. 12;

FIG. 14 is a schematic diagram of a cross-sectional structure of another support member according to some embodiments of the present disclosure;

FIG. 15 is a schematic diagram of a cross-sectional structure of another support member according to some embodiments of the present disclosure;

FIG. 16 is a schematic diagram of a planar structure of the support member in FIG. 15;

FIG. 17 is a schematic diagram of a cross-sectional structure of another support member according to some embodiments of the present disclosure;

FIG. 18 is a schematic diagram of a planar structure of the support member in FIG. 17;

FIG. 19 is a schematic diagram of a cross-sectional structure of another support member according to some embodiments of the present disclosure;

FIG. 20 is a schematic diagram of a planar structure of the support member in FIG. 19;

FIG. 21 is a schematic diagram of a cross-sectional structure of a support member according to some embodiments of the present disclosure;

FIG. 22 is a schematic diagram of an extent that different designs of a support member according to some embodiments of the present disclosure affect the bending force of a display panel or bonding layer in a foldable display device;

FIG. 23 is a flow chart of a method for manufacturing a support member according to some embodiments of the present disclosure; and

FIG. 24 is a schematic diagram of a cross-sectional structure of a foldable display device according to some embodiments of the present disclosure.

### DETAILED DESCRIPTION

For clearer description of the objects, technical solutions and advantages of the present disclosure, the embodiments of the present disclosure are further described in detail hereinafter with reference to the accompanying drawings.

The terms in the section of the detailed description of the present disclosure are merely used for the purpose of explaining the embodiments of the present disclosure, and are not intended to limit the present disclosure. Unless otherwise defined, the technical terms or scientific terms used in the embodiments of the present disclosure shall be taken to mean the ordinary meanings as understood by those of ordinary skill in the art to which the present disclosure belongs. The terms “first,” “second,” “third,” and similar terms used in the description and claims of the present disclosure do not denote any order, quantity, or importance, but rather are merely used to distinguish different components. Similarly, the singular forms “an,” “a,” and “the” are not intended to limit the number but include both singular and plural referents. The term “include” or “comprise” and similar terms are intended to mean that the element or object before “include” or “comprise” covers the elements or objects or equivalents listed after “include” or “comprise,” without excluding other elements or objects. The orientation terms in the present disclosure, for example, “top”, “bottom”, “up”, “down”, “left”, “right”, or the like, are only directions with reference to the accompanying drawings. Therefore, the use of orientation terms is intended to better and more clearly illustrate and understand the embodiments of the present disclosure, and is not intended to indicate or imply that the device or element must have a particular orientation, be constructed and operated in a particular orientation, and is not understood as a limitation to the embodiments of the present disclosure.

A foldable display device generally includes a support member and a display panel, the support member being connected to a back side of the display panel. The support member includes a support layer, and the support member includes a bending region. In order to enable the foldable display device to be folded, an openwork structure is disposed on a portion of the support layer disposed in the bending region. However, the openwork leads to mold imprints on the display panel, which affects the user experience. To improve this problem, the related art provides an isolation layer between the support layer and the display panel, the isolation layer is disposed in the bending region and the isolation layer is made of polymer material. Although the isolation layer improves the mold imprint problem caused by the support layer in the bending region, because the isolation layer and a plurality of adhesive layers in the foldable display device are made of polymer materials, these polymer material layers creep upon multiple bending, and creases are generated in the bending region, which leads to the polymer material layers not being able to be spread out when the foldable display device is unfolded, and leads to a decrease in the flatness of the surface of the foldable display device. The plurality of adhesive layers in the foldable display device include an adhesive layer in the support member (e.g., foam, polyimide (PI), and polyethylene terephthalate (PET)), an adhesive layer between the cover plate and the polarizer, an adhesive layer between the polarizer and the display panel, and an adhesive layer between the display panel and the back film.

Therefore, embodiments of the present disclosure provide a support member. By providing an isolation layer made of a high modulus material in the support member, the mold imprint problem generated in the bending region by the openwork structure of the support layer is improved, and upon multiple bending, the isolation layer helps to restore a flat surface of other layers of polymer material that are creased by creep, i.e., reducing the crease. In addition, the high strength of the isolation layer made of high modulus material also improves the impact resistance of the support member in the bending region.

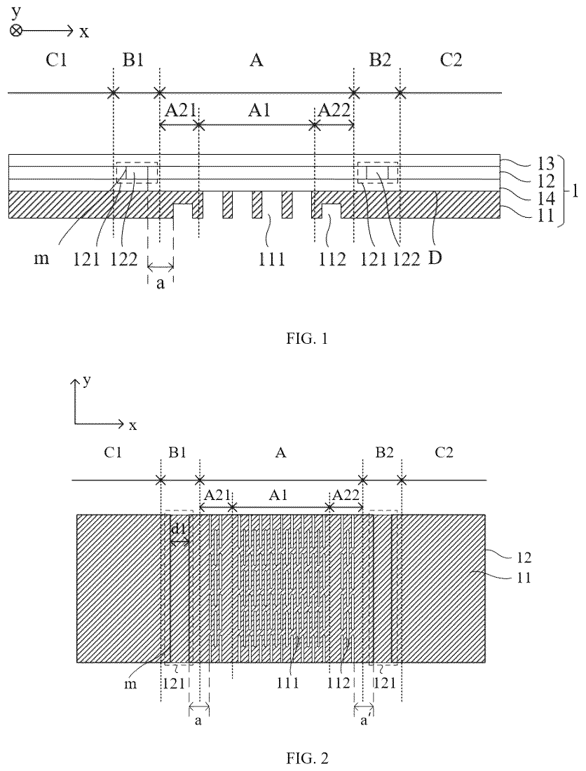

FIG. 1 is a schematic diagram of a cross-sectional structure of a support member according to some embodiments of the present disclosure. The support member is in a spreading state. As shown in FIG. 1, the support member 1 includes a support layer 11 and an isolation layer 12 laminated on a first surface D of the support layer 11. The support layer 11 has a first planar region C1, a bending region A, and a second planar region C2 sequentially connected along a first direction x. The isolation layer 12 is disposed in the first planar region C1, the bending region A, and the second planar region C2, and the isolation layer 12 covers the bending region A (i.e., a portion of the isolation layer 12 in the bending region A is a whole layer structure), and the thickness of the isolation layer 12 is less than the thickness of the support layer 11. A modulus of the isolation layer 12 ranges from 10 GPa to 250 Gpa.

FIG. 2 is a schematic diagram of a planar structure of a support member according to some embodiments of the present disclosure. In conjunction with FIGS. 1 and 2, the length direction of the bending region A is a second direction y, and the second direction y is intersected with the first direction x. The support layer 11 includes a plurality of openwork structures 111 disposed in the bending region A.

For example, the isolation layer 12 is made of a metallic material (e.g., stainless steel, titanium alloy, and aluminum alloy) or an inorganic non-metallic material (e.g., ceramic and glass).

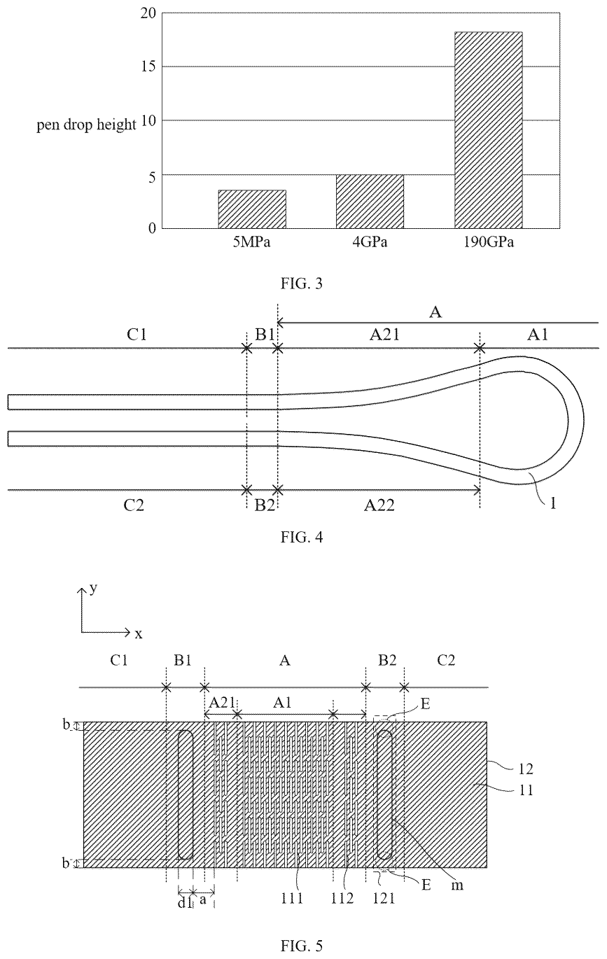

FIG. 3 shows the pen drop test results of the foldable display device using isolation layers of different modulus materials according to some embodiments of the present disclosure. As shown in FIG. 3, the pen drop height of the foldable display device increases with the increasing modulus of the material of the isolation layer, i.e., the impact resistance of the foldable display device increases significantly. The pen drop height of the foldable display device with an isolation layer made of a material whose modulus is 190 GPa (e.g., stainless steel) is about 5 times the pen drop height of the foldable display device with an isolation layer made of a material whose modulus is 5 MPa (e.g., foam material). The pen drop height of the foldable display device with the isolation layer made of a material whose modulus is 190 GPa (e.g., stainless steel) is about 3.5 times the pen drop height of the foldable display device with the isolation layer made of a material whose modulus is 4 GPa (e.g., PI material). It should be noted that the test results in FIG. 3 are normalized, and the vertical coordinates only indicate the proportional relationship of the pen fall heights of the foldable display device with isolation layers of different modulus, and do not represent the value of the specific pen fall height.

For example, as shown in FIG. 1, the support member 1 further includes a first adhesive layer 13, the first adhesive layer 13 is disposed on a side, away from the support layer 11, of the isolation layer 12, and the first adhesive layer 13 is configured to secure the support layer to other structures (e.g., a back film) in the foldable display device. Optionally, the first adhesive layer 13 is a pressure-sensitive adhesive. In other possible embodiments, the first adhesive layer 13 is an optically clear adhesive (OCA), a silicone adhesive, or the like.

For example, as shown in FIG. 1, the support member 1 further includes a second adhesive layer 14, the second adhesive layer 14 being disposed between the isolation layer 12 and the support layer 11, and the second adhesive layer 14 is configured to bond the support layer 11 and the isolation layer 12. Optionally, the second adhesive layer 14 is a pressure-sensitive adhesive. In other possible embodiments, the second adhesive layer 14 is an OCA adhesive, silicone, or the like.

Although the isolation layer 12 made of high modulus material reduces the mold imprints generated by the support layer 11 in the bending region A, and also enhances the impact resistance of the foldable display device. However, in the case that the support member 1 is bent, the isolation layer 12 made of the high modulus material increases the bending force of the plurality of structural layers in the foldable display device, which results in poor delamination, for example, delamination at the light-emitting layer of the display panel. The force of the plurality of structural layers in the foldable display device includes the force of the display panel and the plurality of bonding layers. The plurality of bonding layers include a first bonding layer 13 and a second bonding layer 14 in the support member 1, and also bonding layers outside the support member, such as a bonding layer between a cover plate and a polarizer, a bonding layer between a polarizer and a display panel, and a bonding layer between a display panel and a back film.

FIG. 4 is a schematic diagram of a cross-sectional structure of a support member according to some embodiments of the present disclosure in a bent state. In conjunction with FIGS. 1 and 4, the support member 1 further includes a first transition region B1 and a second transition region B2, the first transition region B1 being disposed between a first planar region C1 and a bending region A, and the second transition region B2 being disposed between the bending region A and a second planar region C2. The isolation layer 12 is also disposed in the first transition region B1 and the second transition region B2.

The embodiments of the present disclosure reduce the bending force of the plurality of structural layers in the foldable display device by forming a recessed pattern in the support member, wherein the recessed pattern is disposed in at least one of the isolation layer 12, the first adhesive layer 13, or the second adhesive layer 14.

The formed recessed pattern in the support member is described below. The embodiment in which only a first recessed pattern is formed in the isolation layer 12 is first described.

As shown in FIGS. 1 and 2, each of the isolation layer 12 disposed in the first transition region B1 and the isolation layer 12 disposed in the second transition region B2 have a first recessed pattern 121. By forming the first recessed pattern in the portion of the isolation layer 12 disposed in the first transition region B1 and the second transition region B2, the bending force of the display panel and the plurality of adhesive layers in the foldable display device is reduced.

For example, the first recessed pattern 121 includes only one first elongated groove m, a dimension of the first elongated groove m along the second direction y is the same a dimension of the isolation layer 12 along the second direction y, and the depth of the first elongated groove m is equal to the thickness of the isolation layer 12. That is, the isolation layer 12 is disconnected at the first transition region B1 and the second transition region B2 to form three portions that are not connected to each other. By forming the first recessed pattern 121 as the first elongated groove m, the bending force of the display panel and the plurality of adhesive layers in the foldable display device is reduced.

For example, the support layer further includes a plurality of recessed structures 112, and the plurality of recessed structures 112 are disposed on both sides of the plurality of openwork structures 111 along the first direction x. The distance between a first elongated groove m closest to the bending region A in the first recessed pattern 121 and a recessed structure 112 closest to the first recessed pattern 121 of the plurality of recessed structures 112 in the support layer 11 along the first direction x ranges from 2 mm to 20 mm. That is, as shown in FIGS. 1 and 2, the distance a between the first elongated groove m in the first transition region B1 and the openwork structure 111 closest to the first transition region B1 of the plurality of openwork structures 111 in the support layer 11 along the first direction x ranges from 2 mm to 20 mm. Along the first direction x, the distance a′ between the first elongated groove m in the second transition region B2 and the openwork structure 111 closest to the second transition region B2 of the plurality of openwork structures 111 in the support layer 11 ranges from 2 mm to 20 mm. In the case that the distance between the first recessed pattern 121 and the openwork structure 111 is too small, the first recessed pattern 121 may enter the bending region A due to the material tolerance and the process tolerance, resulting in that the isolation layer 12 does not have the effect of preventing the support layer 11 from generating the mold imprints in the bending region A. In the case that the distance between the first recessed pattern 121 and the openwork structure 111 is too large, the first recessed pattern 121 and the openwork structure 111 cannot reduce the bending force of the display panel and the plurality of bonding layers in the foldable display device. In the embodiment, the distance a and the distance a′ are equal. In other possible embodiments, the distance a and the distance a′ are not equal. In other possible embodiments, the support layer does not have the recessed structure 112, but only has the plurality of openwork structures 111. In this way, along the first direction x, the distance between the first elongated groove m closest to the bending region A in the first recessed pattern 121 and the openwork structure 111 closest to the first recessed pattern 121 of the plurality of openwork structures 111 in the support layer 11 ranges from 2 mm to 20 mm.

In the embodiments shown in FIGS. 1 and 2, the first recessed pattern 121 includes a first elongated groove m and the first elongated groove m runs through the isolation layer 12, i.e., the ratio of the depth of the first elongated groove m to the thickness of the isolation layer 12 is 1. In the embodiments shown in FIGS. 1 and 2, because the isolation layer 12 includes three portions that are not connected to each other, the processing and formation only depends on the first bonding layer 13 disposed on the isolation layer 12 and the second bonding layer 14 disposed under the isolation layer 12 to maintain the relative distance between these three portions, i.e. to maintain the dimension of the first elongated groove m along the first direction x. Due to the softness of the first bonding layer 13 and the second bonding layer 14, the dimension of the first elongated groove m along the first direction x may change.

In other possible embodiments, compared to the embodiment shown in FIG. 2, the first recessed pattern 121 includes a first elongated groove m, and the depth of the first elongated groove m is less than the thickness of the isolation layer 12. That is, the first elongated groove m does not run through the isolation layer 12, and the isolation layer 12 is not divided into a plurality of portions that are not connected to each other, and thus the change of the dimension of the first recessed pattern 12 along the first direction x is avoided.

For example, the ratio of the depth of the first elongated groove m to the thickness of the isolation layer 12 is at least ⅓. That is, the ratio of the depth of the first elongated groove m to the thickness of the isolation layer 12 ranges from ⅓ to 1. In the case that the depth of the first elongated groove m is too small, the first elongated groove m is not able to have an effect of reducing the bending force of the display panel and the plurality of bonding layers in the foldable display device.

For example, as shown in FIG. 1, the support member 1 further includes a plurality of first filling structures 122, each of the plurality of first filling structures 122 is disposed in the first elongated groove m, and the modulus of the first filling structures 122 is less than the modulus of the isolation layer 12. The first recessed pattern 121 forms a small number of mold imprints in the first transition region B1 and the second transition region B2, and the first filling structures 122 made of a low modulus material improves the mold imprints produced by the first recessed pattern 121, and also meets the bending property of the support member. It is to be noted that the first recessed pattern 121 herein causes a small number of mold imprints in the first transition region B1 and the second transition region B2 indicates that the first recessed pattern 121 produces a smaller number of mold imprints compared to the mold imprints produced by the openwork structure 111 in the support layer 11 in the bending region A in the case that the isolation layer 12 is not provided.

Optionally, a modulus of the first filling structure 122 ranges from 1 MPa to 10 GPa. For example, the first filling structure 122 is made of a thermoplastic polyurethane or rubber, or the like.

For example, as shown in FIG. 2, along the first direction x, the first depression pattern 121 has a first reference point closest to the bending region A, and a second reference point farthest from the bending region A, and the distance d1 between the first reference point and the second reference point ranges from 5 μm to 100 μm. In the embodiment shown in FIG. 2, the distance d1 is the width of the first elongated groove m. The smaller the distance d1 is better, and in the case that the distance d is too large, the mold imprints produced by the isolation layer 12 in the first transition region B1 and the second transition region B2 are more obvious.

FIG. 5 is a schematic diagram of a planar structure of another support member according to some embodiments of the present disclosure. As shown in FIG. 5, the first recessed pattern 121 includes a first elongated groove m, the length direction of the first elongated groove m is the second direction y, the dimension of the first elongated groove m along the second direction y is less than the dimension of the isolation layer 12 along the second direction y, and the depth of the first elongated groove m is equal to the thickness of the isolation layer 12. Compared to the embodiment shown in FIG. 2, the embodiment shown in FIG. 5 is also provided with the first elongated groove m running through the isolation layer 12, but connecting points E are present at the ends of the first elongated groove m. Based on the embodiment shown in FIG. 2, the embodiment shown in FIG. 5 is provided with the connecting points E, such that the isolation layers of the three portions that are not connected in FIG. 2 are connected. The connecting points E avoid a change of the dimension of the first elongated groove m along the first direction x, i.e. avoids a change of the dimension of the first recessed pattern 12 along the first direction x.

For example, as shown in FIG. 5, the dimension b of the connecting point along the second direction y ranges from 0.01 mm to 5 mm. In the case that the dimension b is too small, the connecting point cannot maintain the dimension of the first elongated groove m along the first direction x. In the case that the dimension b is too large, the connecting point cannot better reduce the bending force of the display panel and the plurality of bonding layers in the foldable display device.

In other possible embodiments, the first recessed pattern 121 includes a first elongated groove m, the length direction of the first elongated groove m is the second direction y, the dimension of the first elongated groove m along the second direction y is less than the dimension of the isolation layer 12 along the second direction y, and the depth of the first elongated groove m is less than the thickness of the isolation layer 12.

Optionally, the orthographic projection of the first elongated groove m on the first surface D is a rectangle as shown in FIG. 2, or a rectangle with rounded protrusion at both ends as shown in FIG. 5. In other possible embodiments, the orthographic projection of the first elongated groove at the first surface D is also other shapes with an extending direction along the second direction y, which are not limited in the embodiments of the present disclosure.

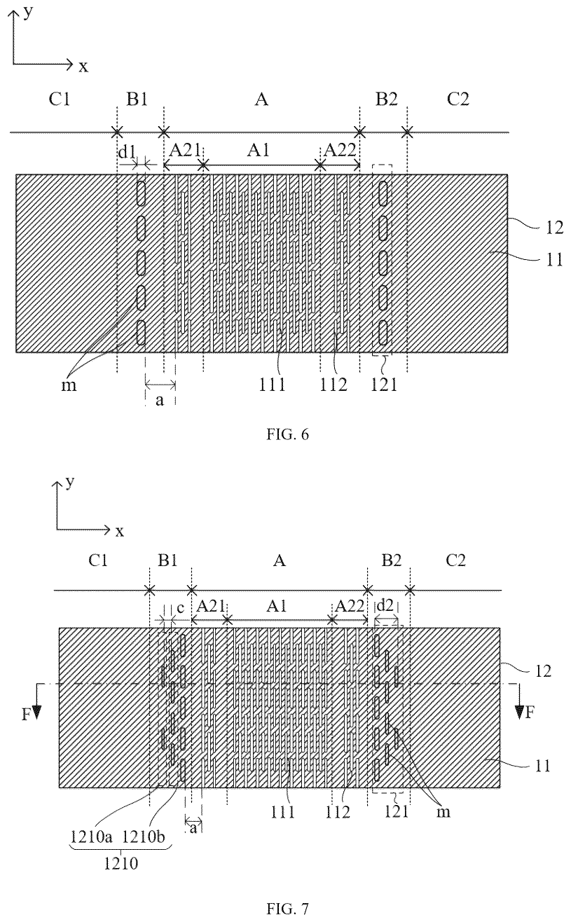

FIG. 6 is a schematic diagram of a planar structure of another support member according to some embodiments of the present disclosure. Compared to the embodiment shown in FIG. 2, in the embodiment shown in FIG. 6, the first depression pattern 121 includes a plurality of first elongated grooves m arranged along the second direction y, and the length direction of the first elongated grooves m is the second direction y. Providing a column of first elongated grooves m in the first depression pattern 121 also reduces the bending force of the display panel and the plurality of adhesive layers in the foldable display device.

FIG. 7 is a schematic diagram of a planar structure of another support member according to some embodiments of the present disclosure. Compared to the embodiment shown in FIG. 6, in the embodiment shown in FIG. 7, the first recessed pattern 121 includes a plurality of first recessed structure groups 1210, the plurality of first recessed structure groups 1210 are arranged in the first direction x, each of the plurality of first recessed structure groups 1210 includes a plurality of first recessed structures arranged along the second direction y, and the length direction of the first recessed structures is the second direction y. For example, the first recessed structure is a first elongated groove m. That is, with the second direction y as the column direction, in the embodiment shown in FIG. 6, the isolation layer 12 disposed in the first transition region B1 includes a column of first elongated grooves m. In the embodiment shown in FIG. 7, the isolation layer 12 disposed in the first transition region B1 includes a plurality of columns of first elongated grooves m. The first recessed pattern 121 of the second transition region B2 is arranged in the same manner as that in the first transition region B1, which is not repeated herein. Forming the plurality of columns of first recessed structures in the first transition region B1 and the second transition region B2 also reduces the bending force of the display panel and the plurality of adhesive layers in the foldable display device. In other possible embodiments, instead of including a plurality of first elongated grooves m arranged along the second direction y, each of the plurality of first recessed structure groups 1210 include a plurality of through holes arranged along the second direction y. Optionally, an orthographic projection of the through hole on the first surface D is a circular or square.

For example, as shown in FIG. 7, the plurality of first recessed structure groups 1210 includes a first target recessed structure group 1210a and a second target recessed structure group 1210b, the first target recessed structure group 1210a and the second target recessed structure group 1210b are adjacent to each other, and the first target recessed structure group 1210a is disposed on the side, away from the bending region A, of the second target recessed structure group 1210b. Each of the orthographic projections of two adjacent first elongated grooves m in the second target recessed structure group 1210b on the reference surface partially is coincident with the orthographic projections of the first elongated grooves m in the first target recessed structure group 1210a on the reference surface, wherein the reference surface is perpendicular to the first surface D and parallel to the second direction y. Arranging the plurality of first elongated grooves m of the first recessed pattern 121 in a staggered manner minimizes the first recessed pattern 121 resulting in mold imprints. In other possible embodiments, the plurality of first elongated grooves m in the first recessed pattern 121 are arranged in an array, rather than staggered as shown in FIG. 7. It is noted that the first target recessed structure group 1210a and the second target recessed structure group 1210b labeled in FIG. 7 are only examples, and any two adjacent first recessed structure groups 1210 of the plurality of first recessed structure groups 1210 in the first recessed pattern 121 are the first target recessed structure group 1210a and the second target recessed structure group 1210b respectively.

For example, as shown in FIG. 7, along the first direction x, the first recessed pattern 121 has a first reference point closest to the bending region A and a second reference point farthest from the bending region A, and the distance d2 between the first reference point and the second reference point ranges from 0.1 mm to 10 mm. In the embodiment shown in FIG. 7, the distance d2 is between two outermost edges of the first stripe groove m of the plurality of columns of first stripe grooves m along the first direction x, and the smaller distance d2 is better. In the case that the distance d2 is too large, the mold imprints produced by the isolation layer 12 in the first transition region B1 and the second transition region B2 are more obvious.

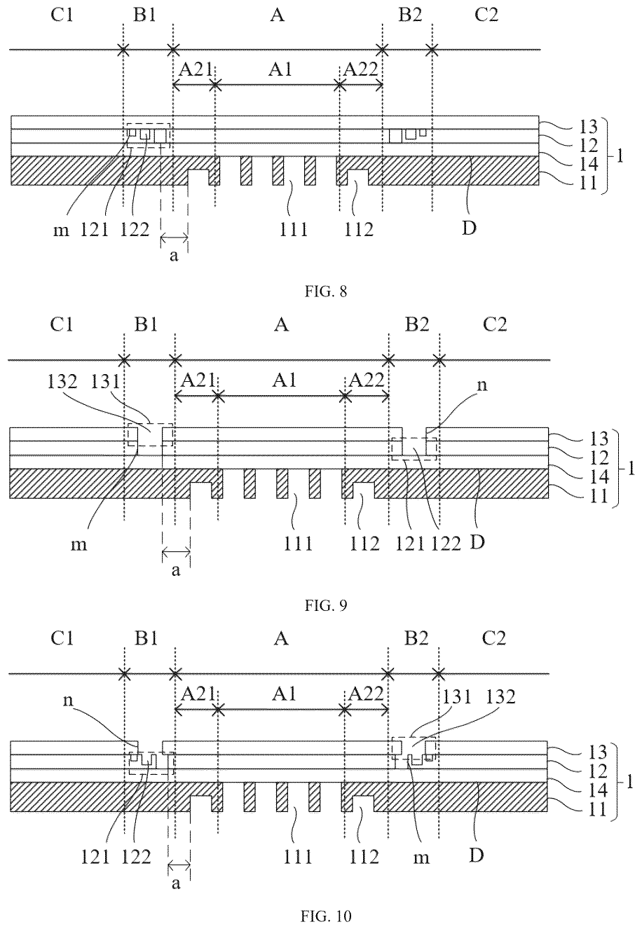

FIG. 8 is a schematic diagram of a cross-sectional structure of another support member according to some embodiments of the present disclosure, and FIG. 8 is a cross-sectional view at the FF cross-sectional line in FIG. 7. For example, as shown in FIGS. 7 and 8, the number of first elongated grooves m in the first target one recessed structure group 1210a is less than the number of first elongated grooves m in the second target one recessed structure group 1210b. The depth of the first elongated groove m in the first target recessed structure group 1210a is less than the depth of the first elongated groove m in the second target recessed structure group 1210b. Along the first direction x, a dimension of the first elongated groove m in the first target recessed structure group 1210a is less than or equal to a dimension of the first elongated groove m in the second target recessed structure group 1210b. Along the second direction y, the dimension of the first elongated groove m in the first target recessed structure group 1210a is less than or equal to the dimension of the first elongated groove m in the second target recessed structure group 1210b. Along the direction from the bending region A to the first planar region C1, or along the direction from the bending region A to the second planar region C2, the number of the first elongated grooves m in the first recessed pattern 121 decreases gradually, the dimension of the first elongated grooves m along both the first direction x and the second direction y decreases gradually, and the depth of the first elongated grooves m decreases gradually. This gradual design minimizes the mold imprints generated by the isolation layer 12 in the first transition region B1 and the second transition region B2. In other possible embodiments, it is also possible to implement the gradual design for any one or two of the number of the first elongated grooves m, the dimensions of the first elongated grooves m along the first direction x and the second direction y, and the depth of the first elongated grooves m, while the other designs remain unchanged, i.e., the gradual design is not implemented.

For example, as shown in FIG. 7, the distance c between two adjacent first recessed structure groups 1210 ranges from 5 μm to 20 μm. The dimension c needs to be as small as possible, and the smaller the dimension c is, the less obvious the mold imprints caused by the isolation layer 12 is, and in the case that the dimension c is too large, the first recessed structure groups 1210 fails to have the effect of reducing the bending force of other structure layers.

For example, as shown in FIG. 7, along the first direction x, in the case that the first recessed pattern 121 includes a plurality of columns of first elongated grooves m, the distance a between one of the first elongated grooves m closest to the bending region A in the first recessed pattern 121 and one of the plurality of recessed structures 112 closest to the first recessed pattern 121 in the support layer ranges from 2 mm to 20 mm.

In all of the above embodiments shown in FIGS. 5 to 8, the first filling structure 122 is disposed in the first recessed pattern 121 to make the mold imprints produced by the first recessed pattern 121 unobvious.

In addition to the above the first recessed pattern 121 formed in the isolation layer 12, the second recessed pattern 131 is also formed in the first adhesive layer 13, and the second recessed pattern 131 is described below.

FIG. 9 is a schematic diagram of a cross-sectional structure of another support member according to some embodiments of the present disclosure. As shown in FIG. 9, each of the first adhesive layer 13 disposed in the first transition region B1 and the first adhesive layer 13 disposed in the second transition region B2 has a second recessed pattern 131. The orthographic projection of the second recessed pattern 131 on the first surface D at least partially is coincident with the orthographic projection of the first recessed pattern 121 on the first surface D. Based on the first recessed pattern 121 formed in the isolation layer 12, the bending force of the display panel and the plurality of adhesive layers in the foldable display device is further reduced by forming the second recessed pattern 131 in the first adhesive layer 13.

For example, as shown in FIG. 9, the orthographic projection of the second recessed pattern 131 on the first surface D is coincident with the orthographic projection of the first recessed pattern 121 on the first surface D, and the second recessed pattern 131 includes at least one second elongated groove n. In forming the support member, the whole layer of the isolation layer 12 and the first bonding layer 13 are first formed, then the isolation layer 12 disposed in the first transition region B1 and a portion of the first bonding layer 13 are removed simultaneously, and the isolation layer 12 and a portion of the first bonding layer 13 disposed in the second transition region B2 along a direction perpendicular to the first direction x and the second direction y are removed simultaneously to save the processes. Along the direction perpendicular to the first direction x and the second direction y, each of the second elongated grooves n runs through the first bonding layer 13. The dimensions of the second elongated grooves n in the second recessed pattern 131 are equal to the first elongated grooves m in the first recessed pattern 121 along the first direction x and the second direction y, which is not repeated herein.

FIG. 10 is a schematic diagram of a cross-sectional structure of another support member according to some embodiments of the present disclosure, FIG. 11 is a schematic diagram of the planar structure of the support member in FIG. 10, and FIG. 10 is a cross-sectional view at the GG cross-sectional line in FIG. 11. As shown in FIGS. 10 and 11, the orthographic projection of the second recessed pattern 131 on the first surface D partially is coincident with the orthographic projection of the first recessed pattern 121 on the first surface D, the dimension of the second elongated groove n along the second direction y is equal to the dimension of the first bonding layer 13 along the second direction y, and the depth of the second elongated groove n is equal to the thickness of the first bonding layer 13. It should be noted that only the planar structure of the isolation layer 12 and the first adhesive layer 13 is shown in FIG. 11, and that the first adhesive layer 13 is patterned and filled in FIG. 11 in order to clearly illustrate the projective relationship between the two. In the embodiments shown in FIGS. 10 and 11, the first adhesive layer 13 includes separated three portions, and the first adhesive layer 13 is formed by applying adhesive in segments, which is a simple forming process. In the embodiments shown in FIGS. 10 and 11, a portion of the orthographic projection of the first recessed pattern 121 on the first surface D is outside of the orthographic projection of the second recessed pattern 131 on the first surface D.

It should be noted that the embodiment illustrated in FIG. 10 is a product that has just been manufactured, and as shown in FIG. 10, the second adhesive layer 13 may enter into the first elongated groove m during actual use.

For example, a dimension of the second elongated groove n along the first direction x ranges from 50 μm to 200 μm.

For example, as shown in FIG. 10, the orthographic projection of the second elongated groove n on the first surface D is within the orthographic projection of the first elongated groove m on the first surface D. In other possible embodiments, the orthographic projection of the first elongated groove m on the first surface D is within the orthographic projection of the second elongated groove n on the first surface D, or the orthographic projection of the first elongated groove m on the first surface D partially is coincident with the orthographic projection of the second elongated groove n on the first surface D.

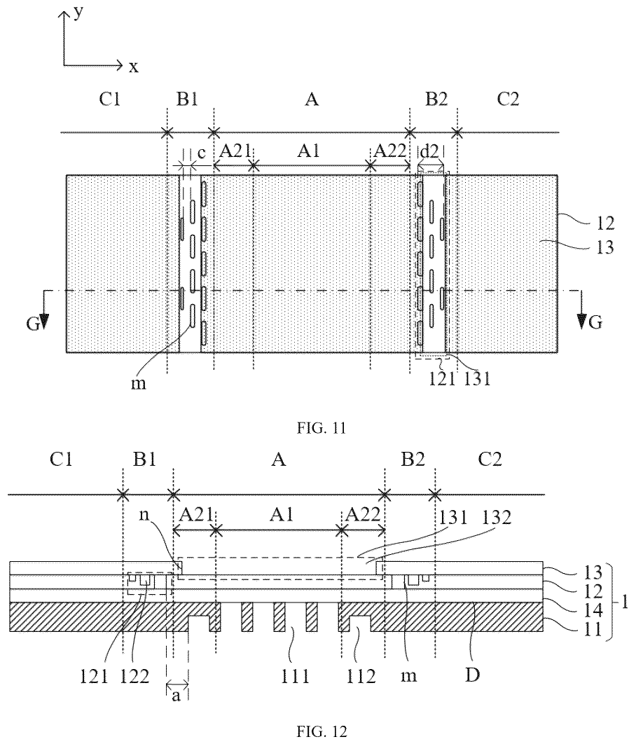

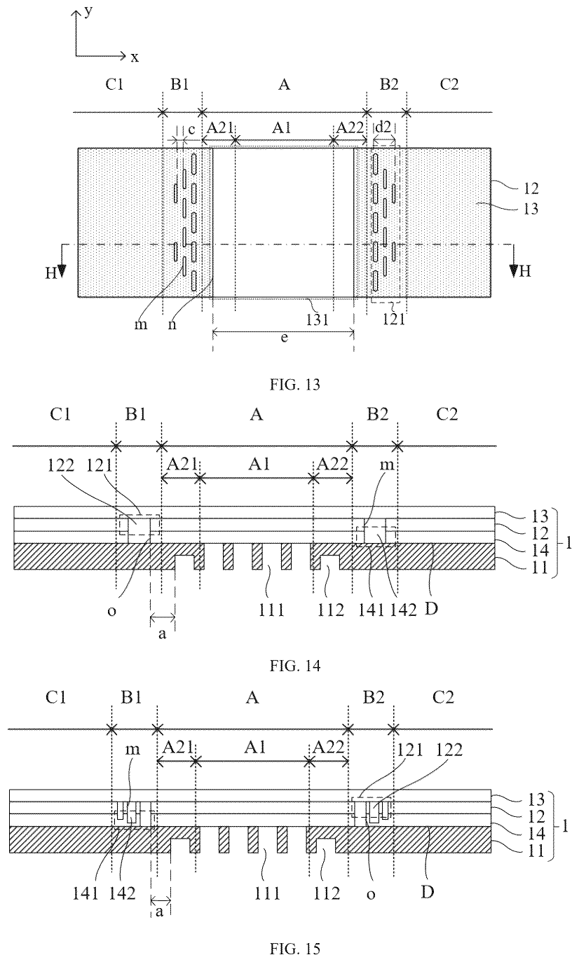

FIG. 12 is a schematic diagram of a cross-sectional structure of another support member according to some embodiments of the present disclosure, FIG. 13 is a schematic diagram of a planar structure of the support member of FIG. 12, and FIG. 12 is a cross-sectional view at the HH cross-sectional line in FIG. 13. As shown in FIGS. 12 and 13, the first adhesive layer 13 disposed in the bending region A has a second recessed pattern 131. In the case that the second recessed pattern 131 is formed in the first adhesive layer 13, the second recessed pattern 131 is formed in the bending region A, instead of forming the second recessed pattern 131 in the first transition region B1 and the second transition region B2, such that the bending force of the display panel and the plurality of adhesive layers in the foldable display device is reduced.

For example, as shown in FIG. 13, the second recessed pattern 131 includes a second elongated groove n, and a dimension e of the second elongated groove n along the first direction x ranges from 1 mm to 30 mm. In the case that the dimension e is too small, the second elongated groove n is not able to achieve the effect of reducing the bending force of the display panel and the plurality of adhesive layers in the foldable display device. In the case that the dimension e is too large, the second elongated groove n causes the display panel on the support member to collapse in the bending region A, the first transition region B1 and the second transition region B2.

In the embodiments shown in FIGS. 10 to 13 above, in the case that the second recessed pattern 131 and the first recessed pattern 121 are not formed simultaneously, the second recessed pattern 131 includes only one second elongated groove n. That is because the process is more complicated in the case that the plurality of second elongated grooves n are only formed in the first bonding layer 13, and the first bonding layer 13 is softer and has a certain degree of mobility, and is not able to maintain the shape of the plurality of second elongated grooves n. Therefore, it is a simple process to form the second elongated groove n through the first adhesive layer 13 to form a second recessed pattern 131 by, for example, die cutting.

For example, the support member 1 further includes a second filling structure 132, the second filling structure 132 being disposed in the second elongated groove n including the second elongated groove n in any of the embodiments shown in FIGS. 9 to 13, and the modulus of the second filling structure 132 being less than the modulus of the isolation layer 12. Providing the second filling structure 132 made of a low modulus material further improves the molding problem due to the removal of a portion of the first adhesive layer 13 in the first transition region B1 and the second transition region B2, or the removal of a portion of the first adhesive layer 13 in the bending region A, and also meets the bending property of the support member.

Optionally, a modulus of the second filling structure 132 ranges from 1 MPa to 10 GPa. For example, the second filling structure 132 is made of a thermoplastic polyurethane, rubber, silicone, or the like.

In addition to the above forming the first recessed pattern 121 in the isolation layer 12, a third recessed pattern 141 is formed in the second adhesive layer 14. The third recessed pattern 141 is described below.

FIG. 14 is a schematic diagram of a cross-sectional structure of another support member according to some embodiments of the present disclosure. As shown in FIG. 14, each of the second adhesive layer 14 disposed in the first transition region B1 and the second adhesive layer 14 disposed in the second transition region B2 has a third recessed pattern 141. The orthographic projection of the third recessed pattern 141 on the first surface D at least partially is coincident with the orthographic projection of the first recessed pattern 121 on the first surface D. Based on forming the first recessed pattern 121 in the isolation layer 12, the bending force of the display panel and the plurality of adhesive layers in the foldable display device is further reduced by forming the third recessed pattern 141 in the second adhesive layer 14.

For example, as shown in FIG. 14, the orthographic projection of the third recessed pattern 141 on the first surface D is coincident with the orthographic projection of the first recessed pattern 121 on the first surface D, and the third recessed pattern 141 includes at least one third elongated groove o. In manufacturing the support member, the whole layer of second adhesive layer 14 and the isolation layer 12 are formed first, and a portion of the isolation layer 12 and a portion of the second bonding layer 14 are removed simultaneously, and the portion of the isolation layer 12 and the portion of the second bonding layer 14 in the second transition region B2 are removed simultaneously along a direction perpendicular to the first direction x and the second direction y to save the processes. Along the first direction x and the second direction y, the dimension of the third elongated groove o in the third recessed pattern 141 is equal to the dimension of the first elongated groove m in the first recessed pattern 121, which is not repeated herein.

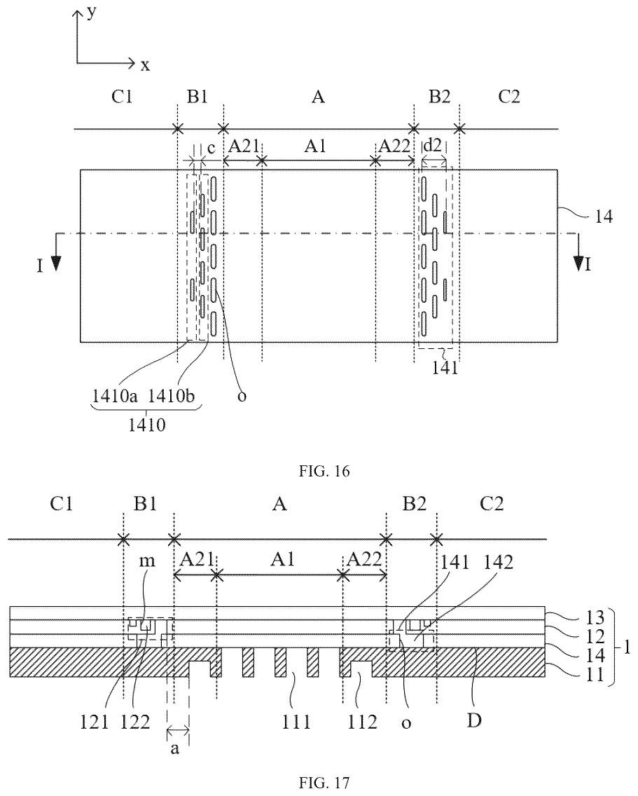

FIG. 15 is a schematic diagram of a cross-sectional structure of another support member according to some embodiments of the present disclosure. As shown in FIG. 15, in the case that the first recessed pattern 121 includes a plurality of columns of first elongated grooves m, and the first recessed pattern 121 and the third recessed pattern 141 are formed simultaneously, the third recessed pattern 141 also includes a plurality of columns of third elongated grooves o. FIG. 16 is a schematic diagram of the planar structure of the support member in FIG. 15, and FIG. 15 is a cross-sectional view at the II cross-sectional line in FIG. 16. As shown in FIG. 16, the third recessed pattern 141 includes a plurality of third recessed structure groups 1410, the plurality of third recessed structure groups 1410 are arranged along the first direction x, and each of the plurality of third recessed structure groups 1410 includes a plurality of third recessed structures arranged along the second direction y. The plurality of third recessed structure groups 1410 include a third target recessed structure group 1410a and a fourth target recessed structure group 1410b, the third target recessed structure group 1410a and the fourth target recessed structure group 1410b being adjacent to each other and the third target recessed structure group 1410a being disposed on the side, away from the bending region, of the fourth target recessed structure group 1410b. The depth of the third recessed structure in the third target recessed structure group 1410a is less than the depth of the third recessed structure in the fourth target recessed structure group 1410b. For example, the third recessed structure is the third elongated groove o. Along a direction from the bending region A to the first planar region C1, or along a direction from the bending region A to the second planar region C2, this design of a gradually decreasing depth of the third elongated groove o minimizes the mold imprints caused by the isolation layer 12 in the first transition region B1 and the second transition region B2. In other possible embodiments, the third recessed structure and the first recessed structure are also both through holes and has the same shape.

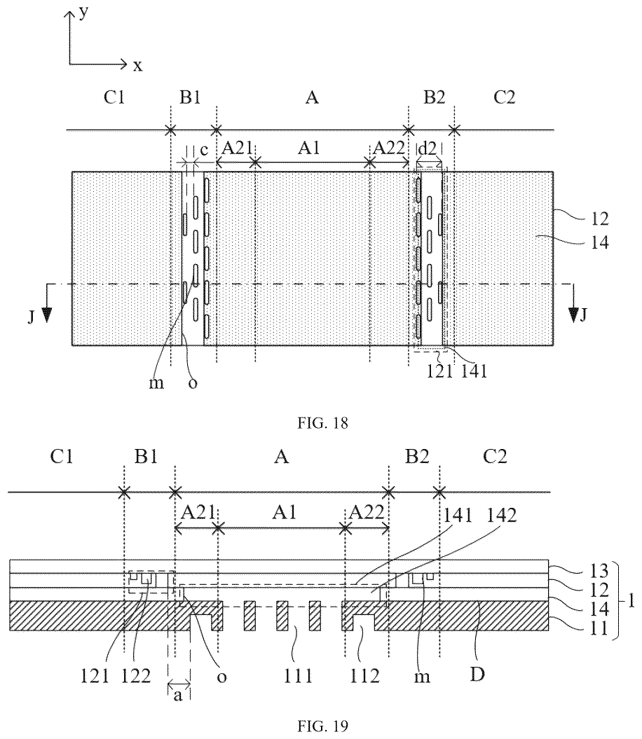

FIG. 17 is a schematic diagram of a cross-sectional structure of another support member according to some embodiments of the present disclosure, FIG. 18 is a schematic diagram of the planar structure of the support member of FIG. 17, and FIG. 17 a cross-sectional view at the JJ cross-sectional line in FIG. 18. As shown in FIGS. 17 and 18, the orthographic projection of the third recessed pattern 141 on the first surface D at least partially is coincident with the orthographic projection of the first recessed pattern 121 on the first surface D. The third recessed pattern 141 includes a third elongated groove o, a dimension of the third elongated groove o along the second direction y is equal to a dimension of the second adhesive layer 14 along the second direction y, and a depth of the third elongated groove o is equal to a thickness of the second adhesive layer 14. It should be noted that only the planar structure of the isolation layer 12 and the second bonding layer 14 is shown in FIG. 18, and the second bonding layer 14 is patterned and filled in FIG. 19 in order to clearly illustrate the projective relationship between the two. In the embodiment shown in FIGS. 17 and 18, the second adhesive layer 14 includes separated three portions, and the second adhesive layer 13 is formed by applying adhesive in segments, which is a simple production process. In the embodiment shown in FIGS. 17 and 18, a portion of the first recessed pattern 121 is disposed outside of the orthographic projection of the third recessed pattern 141 on the first surface D. The third recessed pattern 141 is disposed outside of the orthographic projection of the third recessed pattern 141 on the first surface D. In other possible embodiments, the orthographic projection of the first recessed pattern 121 on the first surface D is within the orthographic projection of the third recessed pattern 141 on the first surface D.

It should be noted that the embodiment illustrated in FIG. 17 is a product that has just been processed, and as shown in FIG. 10, the second adhesive layer 13 gets inside the first elongated groove m during actual use.

For example, a dimension of the third elongated groove o along the first direction x ranges from 50 μm to 200 μm. The orthographic projection of the first elongated groove m on the first surface D is within the orthographic projection of the third elongated groove o on the first surface D, or the orthographic projection of the first elongated groove m on the first surface D partially is coincident with the orthographic projection of the third elongated groove o on the first surface D, or as shown in FIG. 17, the orthographic projection of the third elongated groove o on the first surface D is within the orthographic projection of the first elongated groove m on the first surface D.

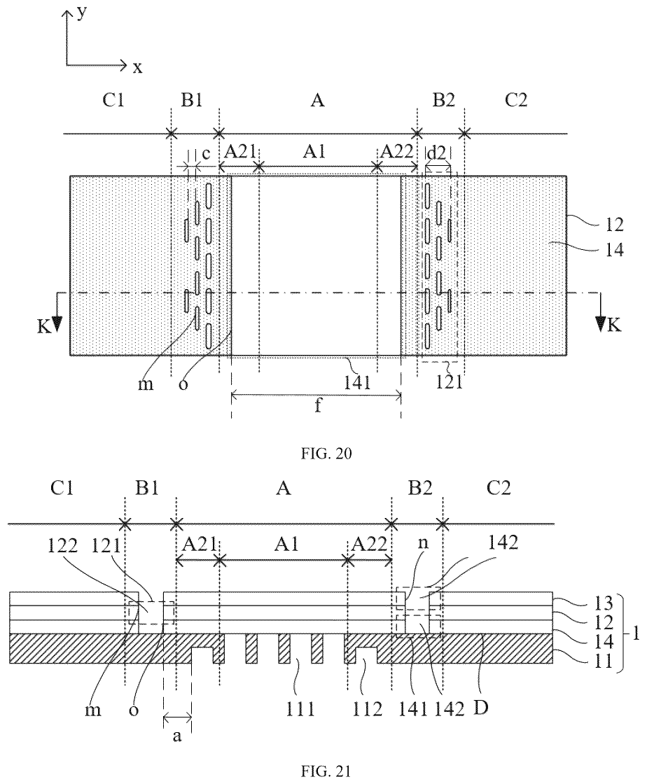

FIG. 19 is a schematic diagram of a cross-sectional structure of another support member according to some embodiments of the present disclosure, FIG. 20 is a schematic diagram of a planar structure of the support member of FIG. 19, and FIG. 19 is a cross-sectional view at the KK cross-sectional line in FIG. 20. As shown in FIGS. 19 and 20, the second adhesive layer 14 disposed in the bending region A has a third recessed pattern 141. In the case that the third recessed pattern 141 is formed in the second adhesive layer 14, the third recessed pattern 141 is possible to be formed in the bending region A, instead of forming the third recessed pattern 141 in the first transition region B1 and the second transition region B2, such that the bending force of the display panel and the plurality of adhesive layers in the foldable display device is reduced.

For example, as shown in FIG. 20, the third recessed pattern 141 includes a third elongated groove o, and a dimension f of the third elongated groove o along the first direction x ranges from 1 mm to 30 mm. In the case that the dimension f is too small, the third elongated groove o is not able to achieve the effect of reducing the bending force of the display panel and the plurality of adhesive layers in the foldable display device. In the case that the dimension f is too large, the third elongated groove o causes the display panel on the support member to collapse in the bending region A, the first transition region B1 and the second transition region B2.

In the embodiment shown in FIGS. 17 to 20 above, in the case that the third recessed pattern 141 and the first recessed pattern 121 are not formed simultaneously, the third recessed pattern 141 includes only one third elongated groove o. That is because the process is more complicated in the case that a plurality of the third elongated grooves o are only formed in the second bonding layer 14, and the second bonding layer 14 is softer and has a certain degree of mobility, and is not able to maintain the shape of the plurality of the third elongated grooves o. Therefore, it is a simple process to form the third elongated groove o through the second adhesive layer 14 to form a third recessed pattern 141 by, for example, die cutting.

For example, the support member 1 further includes a third filling structure 142, the third filling structure 142 being disposed in the third recessed pattern 141 including the third recessed pattern 141 in any of the embodiments shown in FIGS. 14 to 20, and the modulus of the third filling structure 142 being less than the modulus of the isolation layer 14. Providing the third infill structure 142 made of a low modulus material flatly supports the isolation layer, improves the mold imprint problem caused by the isolation layer 12, and also meets the bending property of the support member.

Optionally, a modulus of the third filling structure 142 ranges from 1 MPa to 10 GPa. For example, the second filling structure 132 is made of thermoplastic polyurethane, rubber, silicone, or the like.

In other possible embodiments, the modulus of the third filling structure 142 is less than the modulus of the second adhesive layer 14, and the thermal conductivity of the third filling structure 142 is greater than or equal to 110 w/(m*k), for example, the third filling structure 142 is graphite. Because in the foldable display device, the circuit board is usually disposed under the support member, i.e., the circuit board is disposed on a side close to the support layer 11 and the second adhesive layer 14, providing the third filling structure 142 with a larger thermal conductivity facilitates heat dissipation.

The above embodiments illustrate three cases of forming the first recessed pattern 121, forming the first recessed pattern 121 and the second recessed pattern 131, and forming the first recessed pattern 121 and the third recessed pattern 141. In addition to the above embodiments, it is also possible to simultaneously form the first recessed pattern 121 in the isolation layer 12, the second recessed pattern 131 in the first adhesive layer 13, and the third recessed pattern 121 in the second adhesive layer 14, which include the following cases.

In the first case, the orthographic projection of the first recessed pattern 121 on the first surface D, the orthographic projection of the second recessed pattern 131 on the first surface D, and the orthographic projection of the third recessed pattern 141 on the first surface D coincide with each other. That is, the first recessed pattern 121, the second recessed pattern 131 and the third recessed pattern 141 are formed simultaneously along a direction perpendicular to the first direction x and the second direction y. The first elongated groove runs through the isolation layer 11, the second elongated groove n runs through the first bonding layer 13, and the third elongated groove o runs through or does not run through the second bonding layer 14.

In the second case, the orthographic projection of the first recessed pattern 121 on the first surface D is coincident with the orthographic projection of the third recessed pattern 141 on the first surface D, and the orthographic projection of the first recessed pattern 121 on the first surface D partially is coincident or does not coincide with the orthographic projection of the second recessed pattern 131 on the first surface D. That is, the first recessed pattern 121 and the third recessed pattern 141 are formed simultaneously along a direction perpendicular to the first direction x and the second direction y. The second recessed pattern 131 shown in FIG. 11 is formed in the first bonding layer 13 by, for example, applying adhesive in segments, wherein the first elongated groove m runs through the isolation layer 11, the second elongated groove n runs through the first bonding layer 13, and the third elongated groove o runs through or does not run through the second bonding layer 14.

In the third case, the orthographic projection of the first recessed pattern 121 on the first surface D is coincident with the orthographic projection of the second recessed pattern 131 on the first surface D, and the orthographic projection of the first recessed pattern 121 on the first surface D partially is coincident or does not coincide with the orthographic projection of the third recessed pattern 141 on the first surface D. That is, the first recessed pattern 121 and the second recessed pattern 131 are formed simultaneously along a direction perpendicular to the first direction x and the second direction y, and the third recessed pattern 141 shown in FIG. 18 is formed in the second bonding layer 14 by, for example, applying adhesive in segments. The first elongated groove m runs through or does not run through the isolation layer 11, the second elongated groove n runs through the first bonding layer 13, and the third elongated groove o runs through the second adhesive layer 14.

The depth of the second elongated groove n in the second recessed pattern 131, and the manner of arranging the dimensions along the first direction x and the second direction are described in FIGS. 9 to 13, and the manner of arranging the depth of the third elongated groove o in the third recessed pattern 141, and the dimensions along the first direction x and the second direction are described in FIGS. 14 to 20, which are not repeated herein.

FIG. 21 is a schematic diagram of a cross-sectional structure of a support member according to some embodiments of the present disclosure. FIG. 21 exemplarily illustrates the embodiment that the support member simultaneously includes a first recessed pattern 121, a second recessed pattern 131, and a third recessed pattern 141. As shown in FIG. 21, the orthographic projection of the second recessed pattern 131 on the first surface D is coincident with the orthographic projection of the first recessed pattern 121 on the first surface D, and the orthographic projection of the third recessed pattern 141 on the first surface D is coincident with the orthographic projection of the first recessed pattern 121 on the first surface D. The first recessed pattern 121, the second recessed pattern 131, and the third recessed pattern 141 are formed simultaneously, the number of the second elongated grooves n is equal to the number of the first elongated grooves, the second elongated grooves n are connected to the first elongated grooves in one-to-one correspondence, the number of the third elongated grooves o is equal to the number of the first elongated grooves, the third elongated grooves o one-to-one correspond to the first elongated grooves, and the third elongated grooves o runs through the second adhesive layer 14.

For example, as shown in FIG. 21, the first elongated groove m in the isolation layer 12, the second elongated groove n in the first bonding layer 13, and the third elongated groove o in the second bonding layer 14 are connected correspondingly to form a larger elongated groove. The elongated groove is filled with a heat dissipation material, and then filled with a low modulus material whose modulus is less than the modulus of the first bonding layer or the second bonding layer. The embodiments of the present disclosure do not limit the position of the contact interface between the heat dissipation material and the low modulus material perpendicular to the first direction x and the second direction y.

In summary, forming the first depression pattern 121 in the isolation layer 12 in the first transition region B1 and the second transition region B2 includes the following cases.

In the first case, both the first bonding layer 13 and the second bonding layer 14 are whole layer structures, i.e., the second recessed pattern 131 and the third recessed pattern 141 are not present.

In the second case, the second recessed pattern 131 is disposed in the first bonding layer 13 in the bending region A, or the second recessed pattern 131 is disposed in the first bonding layer 13 in the first transition region B1 and the second transition region B2, or the third recessed pattern 141 is disposed in the second bonding layer 14 in the bending region A, or the third recessed pattern 141 is disposed in the second bonding layer 14 in the first transition region B1 and the second transition region B2.

In the third case, the second recessed pattern 131 is disposed in the first adhesive layer 13 in the bending region A and the third recessed pattern 141 is disposed in the second adhesive layer 14 in the bending region A. Alternatively, the second recessed pattern 131 is disposed in the first adhesive layer 13 in the first transition region B1 and the second transition region B2, and the third recessed pattern 141 is disposed in the second adhesive layer 14 in the first transition region B1 and the second transition region B2. Alternatively, the second recessed pattern 131 is disposed in the first adhesive layer 13 in the bending region A, and the third recessed pattern 141 is disposed in the second adhesive layer 14 in the first transition region B1 and the second transition region B2. Alternatively, the second recessed pattern 131 is disposed in the first adhesive layer 13 in the first transition region B1 and the second transition region B2, and the third recessed pattern 141 is disposed in the second adhesive layer 14 in the first transition region A.

In addition to the above embodiments, instead of forming the first recessed pattern 121 in the isolation layer 12, the second recessed pattern 131 is formed in the first bonding layer 13, and/or the third recessed pattern 121 is formed in the second bonding layer 14, which includes the following cases.

In the first case, the second recessed pattern 131 is disposed only in the first bonding layer 13 in the bending region A, or the second recessed pattern 131 is disposed only in the first bonding layer 13 in the first transition region B1 and the second transition region B2, or the third recessed pattern 141 is disposed only in the second bonding layer 14 in the bending region A, or the third recessed pattern 141 is only disposed in the second bonding layer 14 in the first transition region B1 and the second transition region B2.

In the second case, the second recessed pattern 131 is disposed in the first adhesive layer 13 in the bending region A, and the third recessed pattern 141 is disposed in the second adhesive layer 14 in the bending region A. Alternatively, the second recessed pattern 131 is disposed in the first adhesive layer 13 in the first transition region B1 and the second transition region B2, and the third recessed pattern 141 is disposed in the second adhesive layer 14 in the first transition region B1 and the second transition region B2. Alternatively, the second recessed pattern 131 is disposed in the first adhesive layer 13 in the bending region A, and the third recessed pattern 141 is disposed in the second adhesive layer 14 in the first transition region B1 and the second transition region B2. Alternatively, the second recessed pattern 131 is disposed in the first adhesive layer 13 in the first transition region B1 and the second transition region B2, and the third recessed pattern 141 is disposed in the second adhesive layer 14 in the bending region A.

The arranging manner of the second elongated groove n in the second recessed pattern 131 is described in the above content, and the arranging manner of the third elongated groove o in the third recessed pattern 141 is described in the above content, which are not repeated herein.

In the above two cases, because the first recessed pattern 121 is not formed, the second recessed pattern 131 and the first recessed pattern 121 are not formed simultaneously, and the third recessed pattern 141 and the first recessed pattern 121 are not formed simultaneously. Thus the second recessed pattern 131 includes only one second elongated groove n, and the second elongated groove n runs through the first adhesive layer 13, and/or the third recessed pattern 141 includes only one third elongated groove o, and the third elongated groove o runs through the second adhesive layer 14.

It should be noted that in the case that the support member is used for an inwardly folded product, i.e., in the case that the second bonding layer 14 is outside the first bonding layer 13 in the folded state, the second recessed pattern 131 is considered to be formed first. In the case that the support member is used for an outwardly folded product, i.e., in the case that the second bonding layer 14 is inside the first bonding layer 13 in the folded state, the third recessed pattern 141 is considered to be formed first.

The structure of the support layer 11 is exemplarily described below. Referring again to FIGS. 1 and 2, the bending region A includes a third transition region A21, a bending center region A1, and a fourth transition region A22 sequentially connected along the first direction x. The third transition region A21 is disposed between the first transition region B1 and the bending center region A1, and the fourth transition region A22 is disposed between the bending center region Al and the second transition region B2, and a plurality of openwork structures 111 in the support layer 11 are disposed in the bending center region A1. The openwork structures 111 run through the support layer 11 to facilitate better bending property of the support layer 11.

For example, as shown in FIG. 1, the support layer 11 further includes a plurality of recessed structures 112, the recessed structures 112 being disposed in the third transition region A21 and the fourth transition region A22. The recessed structures 11 do not run through the support layer 11 and are disposed on the side, away from the first surface D, of the support layer 11, which minimizes the mold imprints caused by the support layer 11, and improves the strength of the support member 1 in the bending region A and meets the bending property.

In the embodiment shown in FIG. 1, the distance between the openwork structure 111 closest to the third transition region A21 in the bending center region A1 and the recessed structure 112 closest to the bending center region A1 in the third transition region A21 is larger, and the distance between the openwork structure 111 closest to the fourth transition region A22 in the bending center region A1 and the recessed structure 112 closest to the bending center region A1 in the fourth transition region A22 is larger (e.g., about 5 mm to 15 mm), such that insufficient support of the support member 1 in the bending region A is avoided. In other possible embodiments, the distance between the openwork structure 111 closest to the third transition region A21 in the bending center region A1 and the recessed structure 112 closest to the bending center region A1 in the third transition region A21 is smaller (e.g., about 0.5 mm to 5 mm), and the distance between the openwork structure 111 closest to the fourth transition region A22 in the bending center region A1 and the recessed structure 112 closest to the bending center region Al in the fourth transition region A22 is smaller.

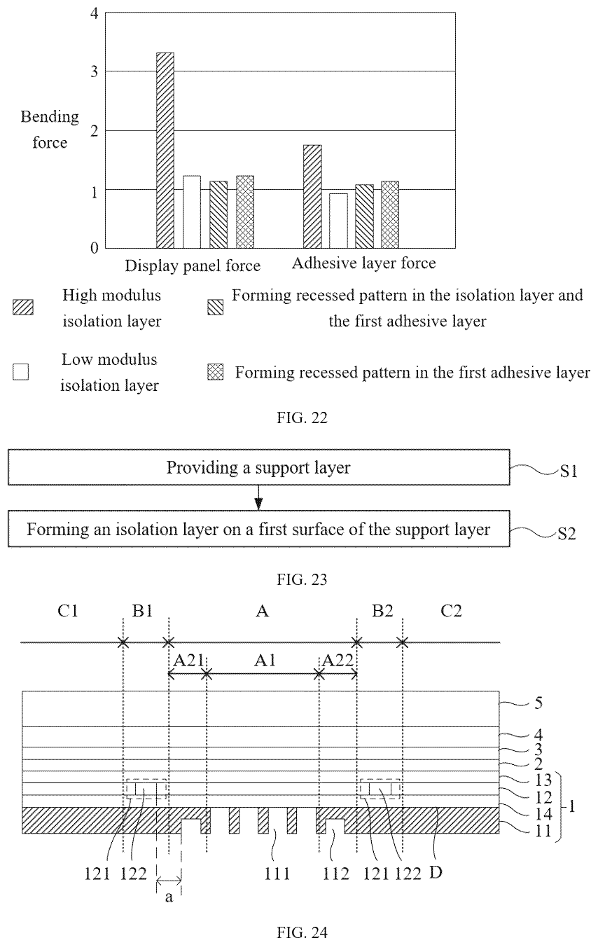

FIG. 22 is a schematic diagram of an extent that different designs of a support member according to some embodiments of the present disclosure affect the bending force of a display panel or bonding layer in a foldable display device. As shown in FIG. 22, in the case that the isolation layer 12 made of a high modulus material is adopted, the bending force of both the display panel and the adhesive layer in the foldable display device is higher, and in particular, the bending force of the display panel is higher. In the case that the isolation layer 12 made of a low modulus material is adopted, the bending forces of both the display panel and the adhesive layer in the foldable display device are smaller. In the case that the first recessed pattern 121 is formed in the isolation layer 12, the bending force of the adhesive layer in both the display panel and the foldable display device is smaller, which is approximate to the design that the bending force of the isolation layer 12 is made of the low modulus material. In the case that the second recessed pattern 131 is formed in the first adhesive layer 13 of the support member, or the third recessed pattern 141 is formed in the second adhesive layer 14, the bending force of the adhesive layer of both the display panel and the foldable display device is smaller, which is approximate to the design that the bending force of the isolation layer 12 is made of the low modulus material. In the test results shown in FIG. 22, the test results corresponding to forming the recessed patterns in the isolation layer 12 and the first adhesive layer 13 refer to the test to the foldable display device including the support member 1 having the first recessed pattern 121 and the second recessed pattern 131 and not having the third recessed pattern 141, and the structure of the support member 1 is shown in FIG. 9. The test result corresponding to forming the recessed pattern in the first adhesive layer 13 refers to the test to the foldable display device including the support member 1 having the second recessed pattern 131 and not having the first recessed pattern 121 and the third recessed pattern 141, and the second recessed pattern 131 of the support member 1 is in the bending region A. It is to be noted that the force of the adhesive layer at the horizontal coordinate refers to the force of the plurality of adhesive layers in the foldable display device. The plurality of adhesive layers include the first adhesive layer 13 and the second adhesive layer 14 in the support member 1, and the adhesive layers outside the support member, such as the adhesive layer between the cover plate and the polarizer, the adhesive layer between the polarizer and the display panel, and the adhesive layer between the display panel and the back film.

FIG. 23 is a flow chart of a method for manufacturing a support member according to some embodiments of the present disclosure. As shown in FIG. 23, the method includes the following processes.

In S1, the support layer is provided;

In S2, an isolation layer is formed on a first surface of the support layer.

The support member includes a first planar region, a bending region and a second planar region sequentially connected along a first direction, an extending direction of the bending region of the support member is a second direction, the second direction is intersected with the first direction, the support layer includes a plurality of openwork structures disposed in the bending region, the isolation layer is disposed in the first planar region, the bending region and the second planar region, the isolation layer includes a whole layer structure disposed in the bending region, a modulus of the isolation layer ranges from 10 GPa to 250 Gpa, and a thickness of the isolation layer is less than a thickness of the support layer.

The process S2 is illustrated exemplarily below by using the structure shown in FIG. 1 as an example. Exemplarily, the process S2 includes the following processes.

In a first process, a whole layer of the second adhesive layer 14 is formed on the support layer 11 by adhesion, and the second adhesive layer covers the bending region A, the first transition region B1, the second transition region B2, the first planar region C1, and the second planar region C2.

In a second process, an entire layer of the isolation layer 12 is formed on the second adhesive layer 14 by adhesion, and the isolation layer 12 covers the bending region A, the first transition region B1, the second transition region B2, the first planar region C1, and the second planar region C2. The first recessed pattern 121 is formed on the isolation layer 12 by laser cutting.

In a third process, the first adhesive layer 13 is formed on top of the isolation layer 12 by adhesion to acquire the support member 1.

The process S2 is illustrated exemplarily below by using the structure shown in FIG. 10 as an example. Exemplarily, the step S2 includes the following processes.

In a first process, a whole layer of the second adhesive layer 14 is formed on the support layer 11 by adhesion, and the second adhesive layer covers the bending region A, the first transition region B1, the second transition region B2, the first planar region C1, and the second planar region C2.

In a second process, a whole layer of the isolation layer 12 is formed on the second adhesive layer 14 by adhesion, and the isolation layer 12 covers the bending region A, the first transition region B1, the second transition region B2, the first planar region C1, and the second planar region C2. The first recessed pattern 121 is formed on the isolation layer 12 by laser cutting.

In a third process, the first adhesive layer 13 is formed on top of the isolation layer 12 by die-cutting to apply adhesive in segments to acquire the support member 1.

FIG. 24 is a schematic diagram of a cross-sectional structure of a foldable display device according to some embodiments of the present disclosure. As shown in FIG. 24, the foldable display device includes a laminated display panel 3 and any one of the above support members 1, and a side, away from the support layer 11, of the support member 1 is connected to a back side of the display panel 3. The back side of the display panel 3 refers to another surface in the display panel opposite to the light-out surface.

Exemplarily, as shown in FIG. 24, the foldable display device further includes a back film 2, the back film 2 being disposed between the display panel 3 and the support member 1, the back film being used to protect the display panel 3.

For example, as shown in FIG. 24, the foldable display device further includes a polarizer 4 and a cover plate 5, the polarizer 4 being disposed on a side, away from the support member 1, of the display panel 3, and the cover plate 5 being disposed on a side, away from the display panel 3, of the polarizer 4.

For example, the foldable display device further includes a plurality of adhesive layers, the plurality of adhesive layers include an adhesive layer disposed between the back film 2 and the display panel 3, an adhesive layer disposed between the display panel 3 and the polarizer 4, and an adhesive layer disposed between the polarizer 4 and the cover plate 5, and the plurality of adhesive layers are made of optical adhesive having a high transparency.

For example, the foldable display decoration further includes a circuit board, the circuit board being disposed on a side, away from the display panel 3, of the support member 1. The circuit board is configured to supply power to the display panel.

For example, the display device according to the embodiments of the present disclosure may be a cell phone, a tablet computer, a television, a monitor, a laptop computer, and any other product or component that has a display function and is foldable.

The foldable display device has the same effect as the above support member and is not repeated herein.

Described above are merely optional embodiments of the present disclosure, and are not intended to limit the present disclosure. Within the spirit and principles of the present disclosure, any modifications, equivalent substitutions, improvements, and the like are within the protection scope of the present disclosure.

1. A support member, comprising a support layer and an isolation layer on a first surface of the support layer; wherein
the support layer has a first planar region, a bending region, and a second planar region sequentially connected along a first direction, wherein a length direction of the bending region is a second direction, the second direction being intersected with the first direction, and the support layer comprises a plurality of openwork structures disposed in the bending region;
the isolation layer is disposed in the first planar region, the bending region, and the second planar region, and covers the bending region; and
a modulus of the isolation layer ranges from 10 GPa to 250 Gpa, and a thickness of the isolation layer is less than a thickness of the support layer.

2. The support member according to claim 1, wherein
the support member further comprises a first transition region and a second transition region, wherein the first transition region is disposed between the first planar region and the bending region, and the second transition region is disposed between the bending region and the second planar region; and
the isolation layer is further disposed in the first transition region and the second transition region, and each of the isolation layer disposed in the first transition region and the isolation layer disposed in the second transition region has a first recessed pattern.

3. The support member according to claim 2, wherein the first recessed pattern comprises a first elongated groove, wherein a dimension of the first elongated groove along the second direction is equal to a dimension of the isolation layer along the second direction, and a depth of the first elongated groove is less than or equal to the thickness of the isolation layer.

4. The support member according to claim 2, wherein the first recessed pattern comprises a first elongated groove, wherein a length direction of the first elongated groove is the second direction, a dimension of the first elongated groove along the second direction is less than a dimension of the isolation layer along the second direction, and a depth of the first elongated groove is equal to the thickness of the isolation layer.

5. The support member according to claim 2, wherein the first recessed pattern comprises a plurality of first elongated grooves arranged along the second direction, wherein a length direction of each of the plurality of the first elongated grooves is the second direction.

6. The support member according to claim 2, wherein along the first direction, the first recessed pattern has a first reference point closest to the bending region and a second reference point farthest from the bending region, and a distance between the first reference point and the second reference point ranges from 5 μm to 100 μm.

7. The support member according to claim 2, wherein the first recessed pattern comprises a plurality of first recessed structure groups, wherein the plurality of first recessed structure groups are arranged along the first direction, each of the plurality of first recessed structure groups comprises a plurality of first recessed structures arranged along the second direction, and a length direction of each of the plurality of first recessed structures is the second direction.

8. The support member according to claim 7, wherein
the plurality of first recessed structure groups comprises a first target recessed structure group and a second target recessed structure group, wherein the first target recessed structure group and the second target recessed structure group are adjacent to each other, and the first target recessed structure group is disposed on a side, away from the bending region, of the second target recessed structure group;
and the first recessed structure is a first elongated groove, and an orthographic projection of each of two adjacent first elongated grooves in the second target recessed structure group on a reference surface partially is coincident with an orthographic projection of the first elongated groove in the first target recessed structure group on the reference surface, wherein the reference surface is perpendicular to the first surface and parallel to the second direction; or
the first target recessed structure group and the second target recessed structure group satisfy at least one of:
a number of the first elongated grooves in the first target recessed structure group being less than or equal to a number of the first elongated grooves in the second target recessed structure group:
a depth of the first elongated groove in the first target recessed structure group being less than or equal to a depth of the first elongated groove in the second target recessed structure group.
along the first direction, a dimension of the first elongated groove in the first target recessed structure group being less than or equal to a dimension of the first elongated groove in the second target recessed structure group; or
along the second direction, a dimension of the first elongated groove in the first target recessed structure group being less than or equal to a dimension of the first elongated groove in the second target recessed structure group.

9. (canceled)

10. The support member according to claim 7, wherein a distance between two adjacent first recessed structure group ranges from 5 μm to 20 μm.

11. The support member according to claim Z, wherein along the first direction, the first recessed pattern has a first reference point closest to the bending region and a second reference point farthest away from the bending region, and a distance between the first reference point and the second reference point ranges from 0.1 mm to 10 mm.

12. The support member according to claim 3, wherein
along the first direction, a distance between the first elongated groove closest to the bending region in the first recessed pattern and one of the plurality of openwork structures closest to the first recessed pattern in the support layer ranges from 2 mm to 20 mm; or
the support layer further comprises a plurality of recessed structures, wherein the plurality of recessed structures are disposed on both sides of the plurality of openwork structures along the first direction, and along the first direction, a distance between the first elongated groove closest to the bending region in the first recessed pattern and one of the recessed structures closest to the first recessed pattern in the first recessed pattern ranges from 2 mm to 20 mm.

13. The support member according to claim 3, wherein a ratio of the depth of the first elongated groove to the thickness of the isolation layer ranges from ⅓ to 1; or
the isolation layer is made of a metallic material or an inorganic non-metallic material.

14. (canceled)

15. The support member according to claim 3, wherein the support member further comprises a plurality of first filling structures, disposed in the first recessed pattern;
wherein a modulus of each of the plurality of first filling structures is less than the modulus of the isolation layer.

16. The support member according to claim 3, wherein the support member further comprises a first adhesive layer, the first adhesive layer being disposed on a side, away from the support layer, of the isolation layer;
wherein each of the first adhesive layer disposed in the first transition region and the first adhesive layer disposed in the second transition region has a second recessed pattern;
wherein an orthographic projection of the second recessed pattern on the first surface at least partially is coincident with an orthographic projection of the first recessed pattern on the first surface; or
the orthographic projection of the second recessed pattern on the first surface partially is coincident with the orthographic projection of the first recessed pattern on the first surface, and the second recessed pattern comprises a second elongated groove, wherein a length direction of the second elongated groove is the second direction, a length of the second elongated groove along the second direction is equal to the dimension of the first adhesive layer along the second direction, and a depth of the second elongated groove is equal to a thickness of the first adhesive layer.

17. (canceled)

18. The support member according to claim 3, wherein the support member further comprises a first adhesive layer, disposed on a side, away from the support layer, of the isolation layer;
wherein the first adhesive layer disposed in the bending region has a second recessed pattern; or
the second recessed pattern comprises a second elongated groove, wherein a dimension of the second elongated groove along the first direction ranges from 1 mm to 30 mm.

19. (canceled)

20. The support member according to claim 16, wherein the support member further comprises a second filling structure, disposed in the second recessed pattern;
wherein a modulus of the second filling structure is less than the modulus of the isolation layer.

21-23. (Canceled)

24. The support member according to claim 3, wherein the support member further comprises a second adhesive layer , disposed between the isolation layer and the support layer;
wherein the second adhesive layer disposed in the bending region has a third recessed pattern.

25. The support member according to claim 24, wherein the third recessed pattern comprises a third elongated groove, wherein a dimension of the third elongated groove along the first direction ranges from 1 mm to 30 mm; or
the support member further comprises a third filling structure, disposed in the third recessed pattern;
wherein a modulus of the third filling structure is less than the modulus of the isolation layer, or the modulus of the third filling structure is less than the modulus of the isolation layer, and a thermal conductivity of the third filling structure is greater than or equal to 110 w/(m*k)

26-27. (Canceled)

28. A method for manufacturing a support member, comprising:
providing a support layer; and
forming an isolation layer on a first surface of the support layer;
wherein the support member has a first planar region, a bending region, and a second planar region sequentially connected along a first direction, wherein an extension direction of the bending region of the support member is a second direction, the second direction being intersected with the first direction; and the support layer comprises a plurality of openwork structures disposed in the bending region, the isolation layer is disposed in the first planar region, the bending region and the second planar region, the isolation layer comprises a whole layer structure disposed in the bending region, a modulus of the isolation layer ranges from 10 GPa to 250 Gpa, and a thickness of the isolation layer is than a thickness of the support layer.

29. A foldable display device, comprising a laminated display panel and a support member as defined in, wherein the support member comprises a support layer and an isolation layer on a first surface of the support layer; wherein
the support layer has a first planar region, a bending region, and a second planar region sequentially connected along a first direction, wherein a length direction of the bending region is a second direction, the second direction being intersected with the first direction. and the support layer comprises a plurality of openwork structures disposed in the bending region;
the isolation layer is disposed in the first planar region, the bending region, and the second planar region, and covers the bending region; and
a modulus of the isolation layer ranges from 10 GPa to 250 Gpa, and a thickness of the isolation layer is less than a thickness of the support layer; and
a side, away from the support layer, of the support member is connected to a back side of the display panel.
